(19) United States
(12) Patent Application Publication
(10) Pub. No.: US 2024/0248986 A1
(43) Pub. Date: Jul. 25, 2024

(54) DETERMINATION METHOD, DETERMINATION DEVICE, AND DETERMINATION PROGRAM

(71) Applicant: NIPPON TELEGRAPH AND TELEPHONE CORPORATION, Tokyo (JP)

(72) Inventors: Daiki CHIBA, Musashino-shi, Tokyo (JP); Mitsuaki AKIYAMA, Musashino-shi, Tokyo (JP)

(73) Assignee: NIPPON TELEGRAPH AND TELEPHONE CORPORATION, Tokyo (JP)

(21) Appl. No.: 18/290,022

(22) PCT Filed: May 12, 2021
(86) PCT No.: PCT/JP2021/018118

§ 371 Date: Nov. 9, 2023

(51) Int. Cl. G06F 21/55

(52) U.S. Cl. CPC G06F 21/554; G06F 2221/034

(57) ABSTRACT

A determination method executed by a determination apparatus includes extracting feature information from an indicator of compromise (IOC) included in information related to cyber security, imparting a label to each of IOCs according to an actual result of a workload required for dealing with a relevant alert, and learning a model for outputting a label from feature information of an IOC by using learning data obtained by combining the feature information extracted with the label imparted.

### TECHNICAL FIELD

The present invention relates to a determination method, a determination apparatus, and a determination program.

### BACKGROUND ART

In order to ensure cyber security in companies and organizations, systems for security management and detection of threats have been introduced. A security operation center (SOC) is an organization that operates such systems. Analysts of an SOC monitor and analyze a large amount of logs and alerts output from systems, and take necessary measures against them.

On the other hand, according to the following References 1 and 2, there is a problem that analysts who have to process large amounts of alerts occurring every day end up in a condition called alert fatigue, which leads to the analysts suffering from burnout.
Reference 1: S. C. Sundaramurthy, A. G. Bardas, J. Case, X. Ou, M. Wesch, J. McHugh, and S. P. Rajagopalan, “A Human Capital Model for Mitigating Security Analyst Burnout,” Proc. SOUPS, 2015.
Reference 2: Ponemon Institute, “Improving the Effectiveness of the Security Operations Center,” 2019.

In addition, what is required to solve the above problem is to realize more excellent automation and reduce the workload of such analysts. In fact, according to Reference 3, many managers of SOCs have recognized that the insufficient automation level of the components of SOCs is the most important task for current SOC organizations.
Reference 3: F. B. Kokulu, A. Soneji, T. Bao, Y. Shoshitaishvili, Z. Zhao, A. Doupe, and G.-J. Ahn, “Matched and Mismatched SOCs: A Qualitative Study on Security Operations Center Issues,” Proc. ACM CCS, 2019.

On the other hand, for example, there has been proposed a technique to discriminate between a truly malicious alert and a fundamentally non-malicious alert that may be incorrectly detected by estimating an abnormality score and a malignancy score of each alert for security from past alerts (see, for example, NPL 1 to NPL 5).

In addition, a technique for supporting subsequent processes of an analyst by extracting information having the highest relevance to each alert for security is known (see, for example, NPL 6 to NPL 8).

### Non Patent Literature

[NPL 1] W. U. Hassan, Guo, D. Li, Z, Chen, K. Jee, Z. Li, and A. Bates, “NoDoze: Combatting Threat Alert Fatigue with Automated Provenance Triage,” Proc. NDSS, 2019.
[NPL 2] A. Oprea, Z. Li, P. Norris, and K. Bowers, “MADE: Security Analytics for Enterprise Threat Detection,” Proc. ACSAC, 2018.
[NPL 3] K. A. Roundy, A. Tamersoy, M. Spertus, M. Hart, D. Kats, Dell'Amico, and R. Scott, “Smoke Detector: Cross-Product Intrusion Detection With Weak Indicators”, Proc. ACSAC, 2017.
[NPL 4] Y. Liu, M. Zhang, D. Li, K. J-ee, Z. Li, Z. Wu, J. Rhee, and P. Mittal, “Towards a Timely Causality Analysis for Enterprise Security,” Proc. NDSS, 2018.
[NPL 5] P. Najafi, A. Muhle, W. Punter., F. Cheng, and C. Meinel, “MalRank: A measure of Maliciousness in SIEM-based Knowledge Graphs,” Proc. ACSAC, 2019.
[NPL 6] C. Zhong, J. Yen, P. Liu, and R. F. Erbacher, “Automate Cyber Security Data Triage by Leveraging Human Analysts' Cognitive Process,” Proc. IEEE IDS, 2016.
[NPL 7] c. Zhong, T. Lin, P. Liu, J. Yen, and K. Chen, “A Cyber Security Data Triage Operation Retrieval System,” Comput. Secur., vol. 76, pp. 12-31, 201.8.
[NPL 8] S. T. Chen, Y. Han, D. H. Chau, C. Gates, M. Hart, and K. A. Roundy, “Predicting Cyber Threats with Virtual Security Products,” Proc. ACSAC, 2017.

### SUMMARY of Invention

### Technical Problem

However, the techniques in the related art have the problem that: the workload of the analysts of an SOC cannot be sufficiently reduced.

For example, all of the techniques described in the related art literature are common in that the analysts are assumed to analyze individual alerts.

Here, in an SOC base having a plurality of analysts, each analyst may perform analysis from a different point of view. In this case, although the techniques of related art capable of obtaining information about individual alerts can improve the efficiency of analysis processing for the individual alerts, the number of analysis operations itself may not be reduced, and it may be difficult to sufficiently reduce the workload of an entire SOC base.

### Solution to Problem

In order to solve the above-mentioned problem and to achieve the purpose, a determination method is a determination method executed by a determination apparatus, and includes a feature information extraction step of extracting feature information from an indicator of compromise (IC) included in information related to cyber security, a labeling step of imparting a label to each of IOCs according to an actual result of a workload required for dealing with a relevant alert, and a learning step of learning a model for outputting a label from feature information of an IOC by using learning data obtained by combining the feature information extracted by the feature information extraction unit with the label imparted in the labeling step.

### Advantageous Effects of Invention

According to the present invention, the workload of an analyst of an SOC can be sufficiently reduced.

### BRIEF DESCRIPTION OF DRAWINGS

FIG. 1 is a diagram for explaining a security system.

FIG. 2 is a diagram illustrating an example of a screen of an alert monitor.

FIG. 3 is a diagram illustrating an example of a screen of an IOC checker.

FIG. 4 is a diagram illustrating a configuration example of a determination apparatus according to a first embodiment.

FIG. 5 is a diagram for explaining a period in which extraction of feature information and labeling are performed.

FIG. 6 is a flowchart showing the flow of a learning process.

FIG. 7 is a flowchart showing the flow of a process of labeling.

FIG. 8 is a flowchart showing the flow of a prediction process.

FIG. 9 is a diagram illustrating an example of a computer that executes determination program.

### DESCRIPTION OF EMBODIMENTS

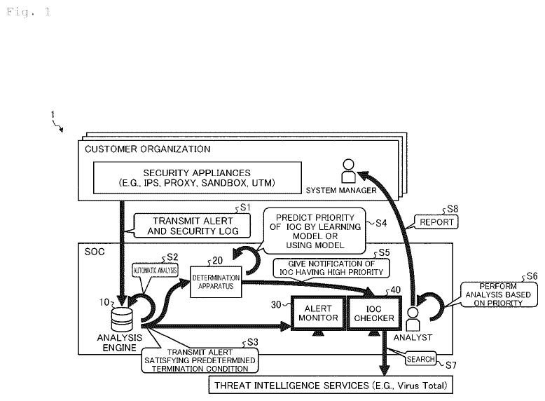

Hereinafter, embodiments of a determination method, a determination apparatus, and a determination program according to the present application will be described in detail with reference to the drawings. Further, the present invention is not limited to the embodiments to be described below.

[Configuration of First Embodiment] First, a security system including a determination apparatus according to a first embodiment will be described with reference to FIG. 1. FIG. 1 is a diagram for explaining a security system.

The security system 1 performs automatic: analysis by an analysis engine or analysis by an analyst based on predetermined information generated in a security appliance of a customer organization.

Examples of the security appliance include, for example, an intrusion protection system (IPS), a proxy, a sandbox, unified threat management (UTM), and the like.

An SOC analyzes information about security acquired from a security appliance in real time. For example, the information about security includes a security log and an alert.

In the example illustrated in FIG. 1, the SOC is used as an outsourced SOC provided by a large scale managed security service provider (MSSP). On the other hand, the present embodiment is also applicable to an in-house SOC.

Although there is a systematic difference between an outsourced SOC and an in-house SOC, their overall workflows are similar. Thus, an in-house SOC can easily obtain the effects of the present embodiment as long as it is an SOC of an organization large enough to take advantage of economy of scale.

The flow of processing in the security system 1 will be described. As illustrated in FIG. 1, first, the security appliance of a customer organization transmits an alert and a security log to an analysis engine 10 of the SOC (step S1).

An example of the case where processing is performed for an alert will be described below. The security system 1 can process security logs in the same manner as that for alerts.

The analysis engine 10 performs automatic analysis (step S2). The analysis engine 10 responds to an alert by performing analysis based on known characteristics of malice, or a rule or a black list defined in advance.

The analysis engine 10 may perform the analysis using a function called security orchestration, automation, and response (SOAR).

The analysis engine 10 transmits an alert satisfying a predetermined condition to a determination apparatus 20, an alert monitor 30 or an IOC checker 40 (step S3).

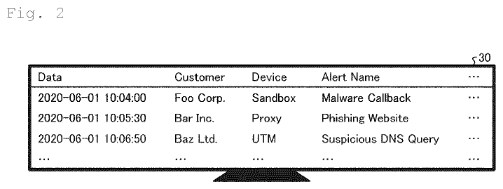

At this time, the alert monitor 30 displays information about the alert as illustrated in FIG. 2. FIG. 2 is a diagram illustrating an example of a screen of the alert monitor.

For example, the alert monitor 30 displays the date (Date) of an event that has caused an alert, a customer name (Customer) the device (Device) that has transmitted the alert, the name of the alert (Alert Name), an outline of the situation that has triggered the alert, and the like.

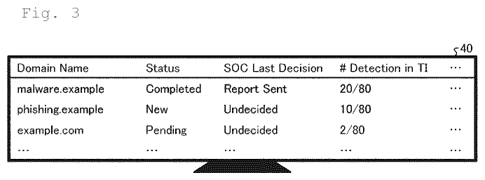

Furthermore, as illustrated in FIG. 3, the IOC checker 40 displays information about an indicator of compromise (IOC) included in an alert. FIG. 3 is a diagram illustrating an example of a screen of the TOC checker.

For example, the IOC includes a domain name, IP address, URL, file hash value, and the like.

As illustrated in FIG. 3, for example, the IOC checker 40 displays an investigation status (Status) in the SOC, the latest determination of the SOC (SOC Last Decision) regarding the malignancy of the IC, and the latest threat intelligence result (Detection in TI) of the 0C, and the like.

For example, an analyst performs triage (evaluation) of the IOC for an alert that cannot be processed by the analysis engine 10 by using a dedicated tool for the IOC evaluation, such as the alert monitor 30 and an IOC checker 40.

The analyst of the SOC processes a large amount of alerts in a daily SOC workflow. Thus, the determination apparatus 20 determines the IOC having a high priority and notifies the analyst of the IOC. This makes it possible to prevent a plurality of analysts from manually evaluating the same IOC in the SOC.

Furthermore, according to the determination apparatus 20, the IOC having a high priority can be analyzed preferentially, and thus the effect on the workload of the analyst can be improved.

The determination apparatus 20 learns a model or predicts the priority of the IOC by using the model (step S4). Then, the determination apparatus 20 determines the IOC having a higher priority based on the prediction result, and issues a notification of the determined IOC (step S5).

For example, the determination apparatus 20 notifies the analyst of the determined IDC via the IOC checker 40.

The analyst executes analysis based on the notified priority (step 36). The analyst may search for a threat intelligence service (e.g., Virus Total) in the course of the analysis (step S7).

Some threat intelligence services provide scores on levels and malignancy of threats. However, fundamentally, such a score does not necessarily determine the next action of the analyst.

For example, an IOC associated with an attack exploiting vulnerability in which a patch has already been deployed may have a high score of malignancy, but the attack may not be an imminent threat in view of protecting a customer organization.

Since the alert analysis by the SOC is not simple as above, it is difficult to completely automate alert analysis, and there are cases where an analyst needs to make a determination.

Therefore, the determination of an IOC having a high priority by the determination apparatus 20 can be useful for securing the time required for the analyst to make a determination and reducing the workload of investigating each IOC.

The analyst finally determines whether the alert to be analyzed and the IOC included in the alert are malignant or non-malignant, further determines whether a report to the customer is necessary, and when the report to the customer is necessary, the analyst reports to a system manager or the like of the customer organization (step S8).

For example, when the analyst has completed evaluation of a certain IOC, the condition that triggers an alert in the analysis engine 10 can be changed based on the result.

For example, if a malicious IOC is clearly identified in the analyst's evaluation, the IOC can be used in the analysis engine 10 as a custom blacklist or a custom signature.

In this case, a log including the same IOC can be automatically detected even for other customers or the SOC. In addition, when an IOC that has been falsely detected or: has a low level of threat: is identified in evaluation, SIEM logic triggering an alert is changed, and the same false detection alert can be prevented from being generated again, resulting in a reduction of the workload of the analyst.

Hereinafter, a process of the determination apparatus 20 to determine an IOC having a high priority will be described in detail together with a configuration of the determination apparatus 20.

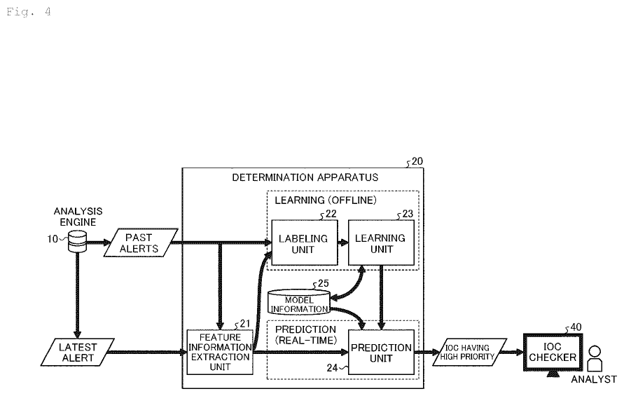

FIG. 4 is a diagram illustrating a configuration example of the determination apparatus according to a first embodiment. As illustrated in FIG. 4, the determination apparatus 20 includes a feature information extraction unit 21, a labeling unit 22, a learning unit 23, a prediction unit 24, and model information 25.

The determination apparatus 20 performs a model learning process with a machine learning method and a prediction processing using a learned model.

In the learning process, the feature information extraction unit 22, the labeling unit 22, and the learning unit 23 are used. In addition, in the prediction process, the feature information extraction unit 21 and the prediction unit 24 are used.

The feature information extraction unit 21 extracts feature information from an TOC included in information about cyber security. For example, the information about cyber security is an alert acquired from the analysis engine 10.

The feature information extraction unit 21 extracts information defining features of the IOC (referred to as feature information hereafter) from the IOC included in the past alert acquired from the analysis engine 10.

The feature information may be a domain name, an IP address, a URL, a file mash value or the like included in the IOC.

For example, the feature information extraction unit 21 extracts feature information from an alert generated in a predetermined fixed number of days.

The labeling unit 2 labels each of IOCs according to the actual result of the workload required for dealing with related alerts.

Here, it is assumed that the labels are binary data indicating whether the priority is high. For example, the labeling unit 22 imparts a label indicating a high priority to an IOC that consumed a heavy workload of the analyst in the past, and imparts a label indicating a non-high priority to an IOC that did not.

Further, in the related art (for example, the techniques described in NPL 4 to NPL 8), a label indicating whether the IOC is malignant (or malicious) is imparted. On the other hand, in the present embodiment, a label is imparted based on the workload of the analyst.

The labeling unit 22 imparts a label indicating a high priority to an IOC for which the number of manual investigations performed for a relevant alert within a certain period is equal to or more than a predetermined value among IOCs, and imparts a label indicating a non-high priority to an IOC for which the number of manual investigations is less than the predetermined value.

In the following description, the label indicating a high priority is referred to as “priority”, and the label indicating a non-high priority is referred to as “non-priority”.

For example, the labeling unit 22 labels the IOC for which K or more manual investigations were performed by an analyst in L days before the labeling time as “priority”, and labels the other IOCs as “non-priority” (where K and L are integers).

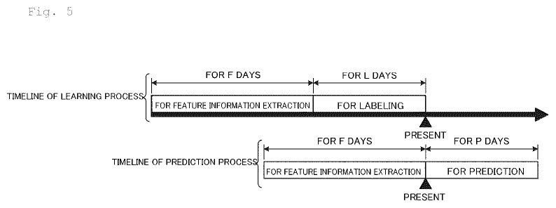

The time line of the learning process shown in FIG. 5 indicates when the labeling unit 22 uses data for labeling. FIG. 5 is a diagram for explaining a period in which extraction of feature information and labeling are performed.

For example, when a labeling time point is a time point represented as “present”, the labeling unit 22 determines whether the IOC was investigated K times or more by the analyst in the last L days.

Thus, the labeling unit 22 can automatically perform labeling by using SOC data from the past to the present.

Furthermore, the labeling unit 22 repeats the labeling operation every time a certain period elapses, so that data with the correct answer label necessary for supervised machine learning can be continuously added.

In addition, since the labeling unit 22 can automatically perform labeling without requiring work from the analyst, daily work of the analyst will not be disturbed.

In this respect, Reference 4 has pointed out that a new tool added at an SOC or security site tends to be an individual solution requiring an analyst's additional work for its maintenance.
Reference 4: M. Vielberth, F. Eohm, I. Fichtinger, and G. Pernul, “Security Operations Center: A Systematic Study and Open Challenges,” IEEE Access, vol. 8, pp. 227756-227779, 2020.

Since the labeling function of the present embodiment automatically executes processing and is free of maintenance, the problem of an increase in the workload of an analyst caused by addition of a tool can be solved.

Further, the labeling unit 22 may impart labels based on the time required for manual investigations, not based on the number or manual investigations.

In this case, the labeling unit 22 may impart a label indicating a high priority to an IOC for which the time required for a manual investigation performed for a relevant alert within a certain period has a value equal to or greater than a predetermined value among IOCs, and impart a label indicating a non-high priority to an IOC for which the time has a value less than the predetermined value.

For example, the Labeling unit 22 labels the IOC for which a manual investigation was performed by an analyst for T hours or more in L days before the labeling time as “priority”, and labels the other IOCs as “non-priority” (where T is a real number).

The learning unit 23 learns a model for outputting a label from feature information of an IOC by using learning data obtained by combining the feature information extracted by the feature information extraction unit 21 with the label imparted by the labeling unit 22.

The learning unit 23 creates and updates the model by supervised machine learning. The model information 25 is information including a parameter and the like for constructing a model. The learning unit 23 creates and updates the model information 25.

The learning unit 23 can adopt an algorithm of known arbitrary supervised machine learning. In the present embodiment, the learning unit 23 is assumed to adopt standard logistic regression.

Logistic regression is scalable and fast, and thus is suitable for predicting an IC included in a large amount of alerts from many customers as in an SOC environment.

In addition, it is also known that logistic regression is highly interpretable. The output of the logistic regression can be interpreted as a probability that an input IOC is prioritized by its nature, and further, it can indicate which feature of feature information corresponding to each IOC contributes to the result. As described above, logistic regression has the advantage of high interpretability.

In this case, the learning unit 23 is assumed to use logistic regression with L1 regularization in particular.

First, when a vector x representing the feature information extracted by the feature information extraction unit 21 is given, the learning unit 23 models a conditional probability y of the label shown in expression (1) as in expression 2).

[Math. 1]

y∈(0(non-priority),1(priority)) (1)

[Math. 2]

p(y=1|x;θ)=σ(θ^{T}x)=1/(1+exp(−θ^{T}x)) (2)

Here, θ is a parameter of the logistic regression model. In addition, σ is a sigmoid function. In addition, it is also assumed that all the features of x are normalized to the range [0, 1].

The learning unit 23 uses a set of learning rata with n labels shown in expression (3) in order to obtain a parameter 3 when minimizing an objective function of expression (4) into which a Hyper parameter λ for determining a degree of regularization is introduced.

$$\begin{matrix}[ Math . 3 ] & \\ {\{ ( {x}_{i} , {y}_{i} ) \}}_{i = 1}^{n} & ( 3 )\end{matrix}$$

$$\begin{matrix}[ Math . 4 ] & \\ {min}_{θ} {\sum }_{i = 1}^{n} - log p ( {y}_{i} \vert {x}_{i} ; θ ) + λ {‖ θ ‖}_{1} & ( 4 )\end{matrix}$$

In the expression (4), the L1 regularized portion λ∥θ∥₁ adds a penalty to the objective function, and has an effect of identifying and reducing feature information that does not contribute significantly.

Such reduction of a feature amount has effects of contributing to prevention of overfitting that matches learning data more than necessary, and reducing a memory usage and makng it easier to concisely interpret results presented to the analyst of the SOC.

The prediction unit 24 predicts a label from the feature information of the IOC by using the model that the learning unit 23 has learned.

The prediction unit 24 uses the model that the learning unit 23 has learned, inputs the feature information corresponding to the IOC included in an alert newly generated in real time, and predicts which IOC will consume a heavy workload of the analyst in the future.

For example, the prediction unit 24 performs prediction by using the logistic regression model constructed based on the model information 25.

For example, the prediction unit 24 predicts a probability that an analyst manually analyzes a target IOC K times or more in P days (where P is an integer).

The prediction unit 24 uses the parameter θ determined by the learning unit 23 to obtain a probability p that the vector z of the feature information corresponding to the IOC is “priority”, and defines a label \hat{ }y (\hat{ } should be right above y) to be predicted in expression (5).

$$\begin{matrix}[ Math . 5 ] & \\ \hat{y} = \{ \begin{matrix}1 , if p ( y \vert x ; θ ) \geq 0.5 \\ 0 , otherwise\end{matrix} & ( 5 )\end{matrix}$$

The determination apparatus 20 outputs an IOC considered to lead to repeated investigation by an analyst of an SOC, that is, an IOC for which the “priority” label is predicted, in order of a higher probability p, based on the label predicted by the prediction unit 24, and presents the result to the analyst.

At that moment, the analyst can use the information presented by the determination apparatus 20 to prioritize the investigation object and efficiently perform triage and detailed analysis.

The analyst of the SOC is required to determine and record what action should be taken for the TOC as much as possible.

According to the present embodiment, the analyst can investigate the IOC having a higher priority and reflect the result in the analysis engine 10. Thus, since the analysis engine 20 can automatically process an alert including the same IOC, the analyst can avoid manually investigating the IOC every time, and the workload of the whole SOC can be reduced.

For example, the analyst investigates the IOC determined to have a high priority, and causes the analysis engine 10 to automatically analyze the IOC based on the result. Thus, since the IOC is not delivered to other analysts, the workload is reduced.

Further, the determination apparatus 20 re-executes the learning process periodically (for example, once a day) off-line to update the model information 25. As illustrated in FIG. 5, the determination apparatus 20 performs the learning process by using data for F+L days.

On the other hand, when the determination apparatus 20 processes the IOC included in the alert from a customer organization in real time, that is, when the determination apparatus performs a prediction process, the feature information is extracted for the MC by using data for the past F days.

Then, the determination apparatus 20 calculates a probability p at which a manual investigation will be performed by an analyst K times or more for P days in the future from the extracted feature information.

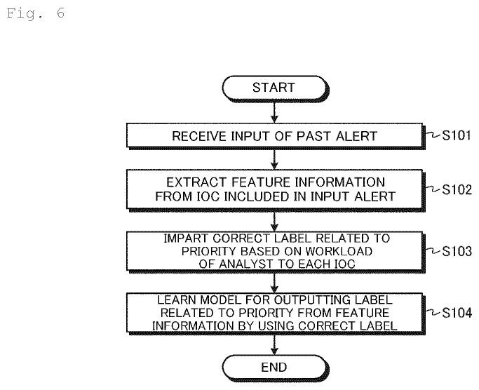

The determination apparatus 20 repeats this prediction process for each IOC received in real time. As a result, a list of IOCs to be preferentially investigated by the analyst is displayed on the screen of the IOC checker 40 as illustrated in FIG. 3 and is continuously updated.

[Process in First Embodiment] FIG. 6 is a flowchart showing the flow of the learning process. As illustrated in FIG. 6, first, the determination apparatus 20 receives input of past alerts (step S101).

Next, the determination apparatus 20 extracts feature information from the IOCs included in the input alerts (step S102). Then, the determination apparatus 20 imparts a correct label related to the priority based on the workload of the analyst for each IOC (step 3103i).

Then, the determination apparatus 20 learns a model for outputting a label related to the priority from the feature information by using the correct label (step S104).

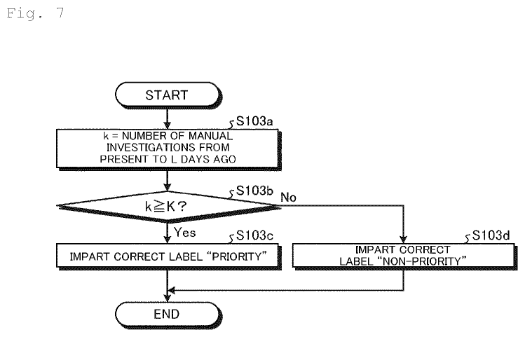

FIG. 7 is a flowchart showing the flow of a process of labeling. The process shown in FIG. 7 corresponds to step S103 in FIG. 6.

First, as shown in FIG. 7, the determination apparatus 20 substitutes k with the number of investigations performed from the present to L days ago (step S103a).

Here, if k is equal to or more than a constant K step S103b, Yes), the determination apparatus 20 imparts the correct label “priority” (step S103c).

On the other hand, if k is less than the constant K (step 3103b, No), the determination apparatus 20 imparts a correct label “non-priorty” (step S103d).

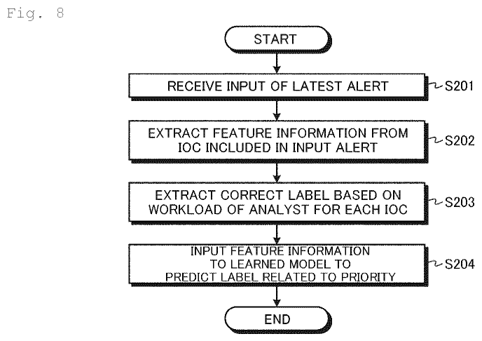

FIG. 8 is a flowchart showing the flow of the prediction process. As shown in FIG. 3, first, the determination apparatus 20 receives input of latest alerts (step 3201).

Next, the determination apparatus 20 extracts the feature information from the IOCs include in the input alerts (step S202). Then, the determination apparatus 20 extracts the correct label based on the workload of the analyst for each IOC (step S203).

Then, the determination apparatus 20 inputs the feature information to the learned model, and predicts a label related to the priority (step S204).

The determination apparatus 20 can notify the analyst of the SOC of the IOC having a high priority based on the predicted label.

[Effects of First Embodiment] As described so far, the feature information extraction unit 21 extracts feature information from an IOC included in information about cyber security. The labeling unit 22 labels each of IOCs according to the actual result of the workload required for dealing with related alerts. The learning unit 23 learns a model for outputting a label from feature information of an IOC by using learning data obtained by combining the feature information extracted by the feature information extraction unit 21 with the label imparted by the labeling unit 22.

Thus, the model learned by the determination apparatus 20 is used to notify the analyst of the IOC having a high priority, and the workload of the whole SOC can be reduced.

The labeling unit 22 imparts a label indicating a high priority to an IOC for which the number of manual investigations performed for a relevant alert within a certain period is equal to or more than a predetermined value among IOCs, and imparts a label indicating a non-high priority to an IOC for which the number of manual investigations is less than the predetermined value.

Thus, the determination apparatus 20 can predict the priority based on the number of manual investigations by using the learned model, and inform the analyst of the result.

The labeling unit 22 imparts a label indicating a high priority to an IOC for which the time required for a manual investigation performed for a relevant alert within a certain period has a value equal to or greater than a predetermined value among IOCs, and imparts a label indicating a non-high priority to an IOC for which the time has a value less than the predetermined value.

Thus, the determination apparatus 20 can predict the priority based on the time of the manual investigation by using the learned model and inform the analyst of the result.

The prediction unit 24 predicts a label from the feature information of the IOC by using the model that the learning unit 23 has learned. In addition, the prediction unit 24 notifies the analyst of information about the IOC for which a label indicating a high priority is predicted.

Thus, the determination apparatus 20 can notify the analyst of the IOC having the high priority, and can reduce the workload of the whole SOC.

[System Configuration, Etc.] Furthermore, each constituent component of each illustrated apparatus is a functional conceptual component and does not necessarily need to be physically configured as illustrated in the drawings. That is, a specific form of distribution and integration of the respective apparatuses is not limited to the form illustrated in the drawings, and all or some of the apparatuses can be distributed or integrated functionally or physically in any units according to various loads, and use situations. Further, all or any part of processing functions to be performed in each apparatus can be realized by a central processing unit (CPU) and a program analyzed and executed by the CPU, or can be realized as hardware using a wired logic. Further, the program may be executed not only by the CPU but also by another processor such as a GPU.

Further, all or some of the processing described as being performed automatically among the processing described in the present embodiment can be performed manually, and alternatively, all or some of the processing described as being performed manually can be performed automatically using a known method. In addition, information including the processing procedures, control procedures, specific names, and various types of data or parameters illustrated in the above literature or drawings can be arbitrarily changed unless otherwise described.

[Program] As an embodiment, the determination apparatus 20 can be implemented by installing a determination program for executing the determination process in a desired computer as packaged software or on-line software. For example, it is possible to cause an information processing apparatus to function as the determination apparatus 20 by causing the information processing apparatus to execute the determination program. Here, the information processing apparatus mentioned here includes a desktop or laptop personal computer. Furthermore, a mobile communication terminal such as a smart phone, a mobile phone, or a persona: handyphone system (PHS), or a slate terminal such as a personal digital assistant (PDA), for example, is included in the category of the information processing apparatus.

The determination device 20 may also be implemented as a determination server apparatus which provides a service related to the determination process to a client which is a terminal apparatus used by a user. For example, the determination server apparatus is implemented as a server apparatus that provides a determination service in which an alert on security is received as an input and an IOC having a high priority is output. In this case, the determination server apparatus may be implemented as a web server or as a cloud that provides services related to the determination process described above by outsourcing.

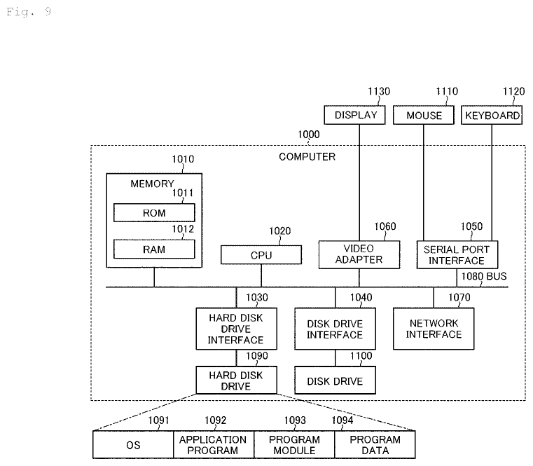

FIG. 9 is a diagram illustrating an example of a computer that executes a determination program. A computer 1000 includes, for example, a memory 1010 and a CPU 1020. Furthermore, the computer 1000 also includes a hard disk drive interface 1030, a disk drive interface 1040, a serial port interface 1050, video adapter 1060, and a network interface 1070. These units are connected to one another via a bus 1080.

The memory 1010 includes a read only memory (ROM) 1011 and a random access memory (PAM) 1012. The ROM 1011 stores, for example, a boot program such as a Basic Input Output System (BIOS). The hard disk drive interface 1030 is connected to the hard disk drive 1090. The disk drive interface 1040 is connected to a disk drive 1100. For example, a removable storage medium such as a magnetic disk or an optical disc is inserted into the disk: drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program defining Each processing operation of the determination apparatus 20 is implemented as the program module 1093 in which codes that can be executed by a computer are described. The program module 1093 is stored in, for example, the hard disk drive 1090. For example, the program module 1093 for executing the same processing as the functional configuration of the determination apparatus 20 is stored in the hard disk drive 1090. Further, the hard disk drive 1090 may be replaced with a solid state drive (SSD).

Furthermore, configuration data to be used in the processing of the embodiment described above is stored as the program data 1094 in, for example, the memory 1010 or the hard disk drive 1090. The CPU 1020 reads the program module 1093 or the program data 1094 stored in the memory 1010 or the hard disk drive 1090 into the RAM 1012 as necessary, and executes the processing of the above-described embodiment.

The procorum module 1093 and program data 1094 are not limited to being stored in the hard disk drive 1090 and may also be stored in, for example, a removable storage medium to be read by the CPU 1020 via the disk drive 1100 or the like. Alternatively, the program module 1093 and the program data 1094 may be stored in another computer connected via a network (a local area network. (LAN), a wide area network (WAN), or the like). In addition, the program module 1093 and the program data 1094 may be read by the CPU 1020 from another computer via the network interface 1070.

### REFERENCE SIGNS LIST

1 Security system
10 Analysis engine
20 Determination apparatus
21 Feature information extraction unit
22 Labeling unit
23 Learning unit
24 Prediction unit
25 Model information
30 Alert monitor
40 IOC checker

1. A determination method executed by a determination apparatus, the determination method comprising:
extracting feature information from an indicator of compromise (IOC) included in information related to cyber security;
imparting a label to each of IOCs according to an actual result of a workload required for dealing with a relevant alert; and
learning a model for outputting a label from feature information of an IOC by using learning data obtained by combining the feature information extracted with the label imparted.

2. The determination method according to claim 1, wherein a label indicating a high priority is imparted to an IOC for which a number of manual investigations performed for a relevant alert within a certain period is equal to or more than a predetermined value among IOCs, and a label indicating a non-high priority is imparted to an IOC for which the number of manual investigations is less than the predetermined value.

3. The determination method according to claim 1, wherein a label indicating a high priority is imparted to an IOC for which a time required for a manual investigation performed for a relevant alert within a certain period has a value equal to or greater than a predetermined value among IOCs, and a label indicating a non-high priority is imparted to an IOC for which the time has a value less than the predetermined value.

4. The determination method according to claim 1, further including: predicting a label from the feature information of the IOC using the model that is learned.

5. The determination method according to claim 4, further including: notifying of information about the IOC for which a label indicating a high priority is predicted.

6. A determination apparatus comprising:
processing circuitry configured to:
extract feature information from an indicator of compromise (IOC) included in information related to cyber security;
impart a label to each of IOCs according to an actual result of a workload required for dealing with a relevant alert; and
learn a model for outputting a label from feature information of an IOC by using learning data obtained by combining the feature information extracted with the label imparted.

7. A non-transitory computer-readable recording medium storing therein a determination program that causes a computer to execute a process comprising:
extracting feature information from an indicator of compromise (IOC) included in information related to cyber security;
imparting a label to each of IOCs according to an actual result of a workload required for dealing with a relevant alert; and
learning a model for outputting a label from feature information of an IOC by using learning data obtained by combining the feature information extracted with the label imparted.
